(19) United States
(12) Patent Application Publication
(10) Pub. No.: US 2024/0424992 A1
(43) Pub. Date: Dec. 26, 2024

(54) CONSOLE

(71) Applicant: TOYODA GOSEI CO., LTD., Kiyosu-shi (JP)

(72) Inventors: Naoki NOMOTO, Kiyosu-shi (JP); Masanori MIZUNO, Kiyosu-shi (JP); Kazuya IZAWA, Kiyosu-shi (JP)

(21) Appl. No.: 18/664,943

(22) Filed: May 15, 2024

(30) Foreign Application Priority Data
Jun. 23, 2023 (JP) 2023-103467

(51) Int. Cl. B60R 7/04; B60N 3/00; B60N 3/10

(52) U.S. Cl. CPC B60R 7/04; B60N 3/001; B60N 3/10

(57) ABSTRACT

A console includes a console body and a table configured to be used in a position in which the table extends away from the console body. A direction in which the table extends away from the console body is referred to as a first direction, and a direction intersecting the first direction is referred to as a second direction. An upper surface of the console body includes a first recess and a second recess. The first recess is adjacent to the table. The second recess is adjacent to the first recess in the second direction.

### CROSS-REFERENCE TO RELATED APPLICATIONS

This application is based upon and claims the benefit of priority from prior Japanese Patent Application No. 2023-103467, filed on Jun. 23, 2023, the entire contents of which are incorporated herein by reference.

### BACKGROUND

### 1. Field

The present disclosure relates to a console.

### 2. Description of Related Art

In an automobile, a console for accommodating small items is often placed between adjacent automobile seats (refer to, for example, Japanese Laid-Open Patent Publication No. 9-118166).

The console disclosed in Japanese Laid-Open Patent Publication No. 9-118166 includes a plate-shaped table. The table, when not in use, is accommodated in a console body. When in use, the table is held to project sideward from the upper portion of the console body.

The console disclosed in the publication has a flat upper surface. Thus, when an occupant accidentally pushes an item placed on the table in use toward the console, the item may move beyond the console and fall onto the floor or the like at the side opposite to the table. In this case, the occupant needs to pick up the item pushed beyond the console.

### SUMMARY

It is an objective of the present disclosure to provide a console that, when an occupant pushes an item toward the console on a table projecting from the console, avoids the movement of the pushed item out of the console and allows easy collection of the pushed item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a console includes a console body and a table configured to be used in a position in which the table extends away from the console body. A direction in which the table extends away from the console body is referred to as a first direction, and a direction intersecting the first direction is referred to as a second direction. An upper surface of the console body includes a first recess and a second recess. The first recess is adjacent to the table. The second recess is adjacent to the first recess in the second direction.

Other features and aspects will be apparent from the following detailed description, the drawings, and the claims.

### BRIEF DESCRIPTION OF THE DRAWINGS

FIG. 1 is a partial perspective view of a console according to a first embodiment in which a side table is positioned at an accommodation position and an armrest is positioned at a reference position.

FIG. 2 is a partial perspective view of the console in which the side table is moved from the state of FIG. 1 to a usage position.

FIG. 3 is a partial perspective view of the console in which the armrest is further moved from the state of FIG. 2 to an extended position.

FIG. 4 is an exploded perspective view of a shaft portion and a retainer in the first embodiment.

FIG. 5 is an exploded perspective view of a bracket cover and vertical rails in the first embodiment.

FIG. 6 is a partial cross-sectional view taken along line 6-6 of FIG. 1.

FIG. 7 is a partial cross-sectional view taken along line 7-7 of FIG. 1.

FIG. 8 is a partial cross-sectional view taken along line 8-8 of FIG. 2.

FIG. 9 is a perspective view of a console according to a second embodiment when the armrest is positioned at the reference position and in a non-raised state.

FIG. 10 is a perspective view of the console of the second embodiment when the armrest is positioned at the extended position and in the non-raised state.

FIG. 11 is a perspective view of the console of the second embodiment when the armrest is positioned at the reference position and in a raised state.

FIG. 12 is a perspective view of the console of the second embodiment when the armrest is positioned at the extended position and in the raised state.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

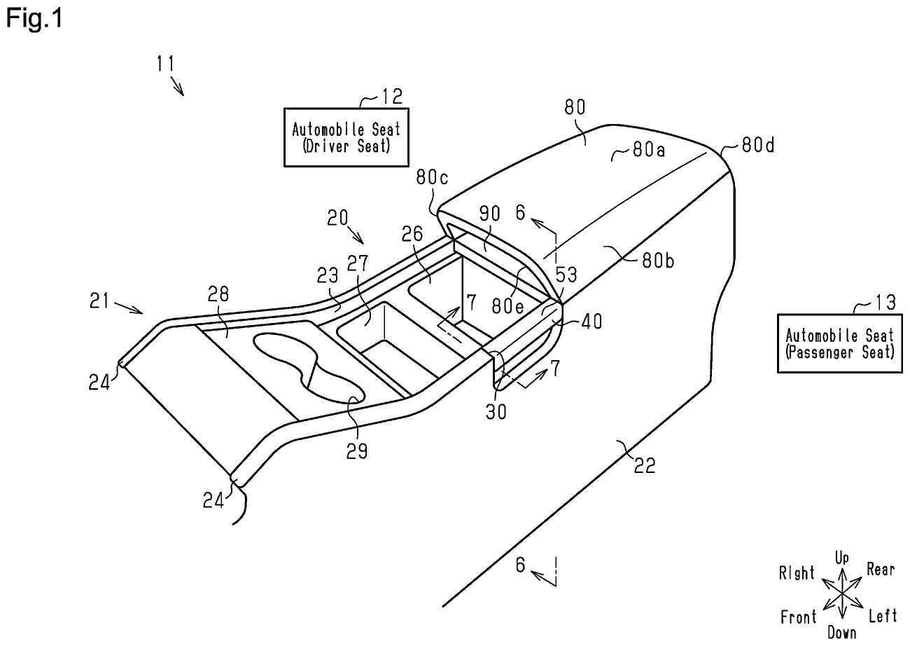

An automobile console according to a first embodiment will now be described with reference to FIGS. 1 to 8.

In the following description, the forward direction of an automobile will be referred to as the front, and the reverse direction will be referred to as the rear. The vertical direction refers to the vertical direction of the automobile, and the right-left direction refers to the vehicle width direction that matches the right-left direction when the vehicle is advancing forward. In the present embodiment, a left direction corresponds to a first direction of the present disclosure. The forward direction corresponds to a second direction intersecting the first direction.

As shown in FIG. 1, two automobile seats 12 and 13 are arranged as front seats spaced apart from each other in the right-left direction inside a passenger compartment 11 of the automobile. The automobile seat 12 on the right is a driver seat. The automobile seat 13 on the left is a passenger seat.

A console (also referred to as a center console, a floor console, or the like) 20 that serves as a box-shaped accommodation unit is placed between the automobile seats 12 and 13.

In the description of each portion of the console 20, the central portion in the right-left direction (width direction of the automobile seats 12 and 13) is used as a reference. In the right-left direction, the direction toward the central portion may be referred to as “inside,” “inward,” “inner side,” or the like, and the direction away from the central portion may be referred to as “outside,” “outward,” “outer side,” or the like.

As shown in FIG. 1, the console 20 includes a console body 21, a side table 40, an armrest 80, and a center table 90. The side table 40 corresponds to a table of the present disclosure.

### 1. Console Body 21

As shown in FIG. 1, the console body 21 forms the framework of the console 20. The console body 21 is made of, for example, a plastic material and formed in an elongated shape that is longer in the front-rear direction than in the right-left direction.

The opposite sides of the console body 21 on the right and left are formed by outer walls 22. An inner wall 23 is arranged at a location spaced inward from each outer wall 22.

As shown in FIG. 1, upper walls 24 are arranged between the upper ends of the outer wall 22 and the inner wall 23, which are adjacent to each other, to cover a large portion in the front-rear direction.

As shown in FIG. 1, the upper walls 24 have upper surfaces that are substantially horizontal in the central portions and the rear portions. The front portions of the upper surfaces of the upper walls 24 are formed obliquely to increase in height toward the front.

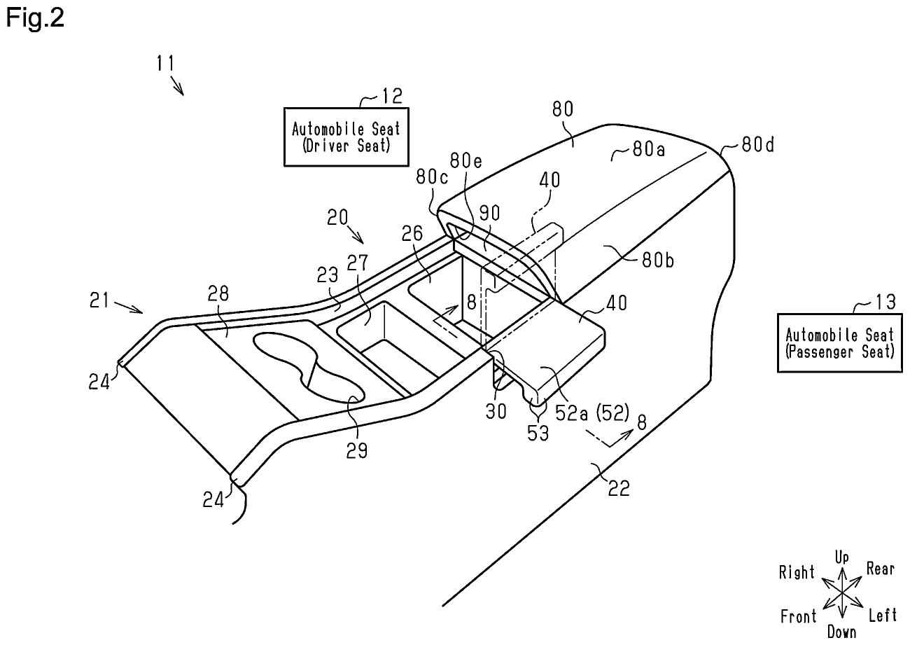

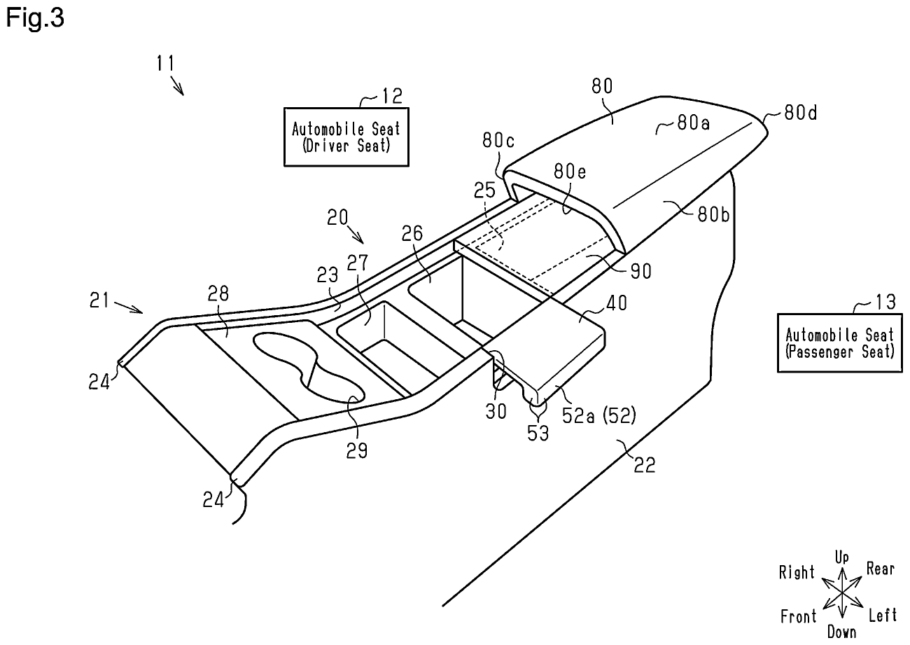

As shown in FIG. 3, a recess 25 having an open upper end and a relatively large capacity is arranged in an upper surface between the inner walls 23 in the rear portions. In FIGS. 1 and 2, the recess 25 is covered by the armrest 80 and the center table 90. In FIG. 3, the recess 25 is covered by the center table 90.

A recess 26 having an open upper end and a capacity that is less than the capacity of the recess 25 is arranged in the upper surface between the inner walls 23 at a location adjacent to the front of the recess 25. The recess 26 corresponds to a first recess.

A recess 27 having an open upper end and a capacity that is less than the capacity of the recess 26 is arranged in the upper surface between the inner walls 23 at a location adjacent to the recess 26 in the forward direction (second direction). The recess 27 corresponds to a second recess.

The use of the recesses 25, 26, and 27 is not limited to accommodation of items and may be changed. The recess may have a design aspect. Alternatively, a connection terminal or the like to which a rechargeable device is connected may be arranged in the recess.

On the upper surface between the inner walls 23, an upper surface 28 at a location adjacent to the front of the recess 26 is an inclined surface having a height that increases toward the front. In other words, the upper surface 28 is an inclined surface having a height that decreases toward the first recess (toward recess 26). A cup holder 29 is recessed in the upper surface 28. In the present embodiment, the cup holder 29 is recessed into a shape resembling a dumbbell such that the opposite ends on the right and left are substantially circular, allowing for detachable placement of two cups or the like. The shape of the cup holder 29 is not limited to the shape resembling a dumbbell, and may be other shapes such as a rectangular shape or a circular shape in plan view.

### 2. Side Table 40 and its Arrangement

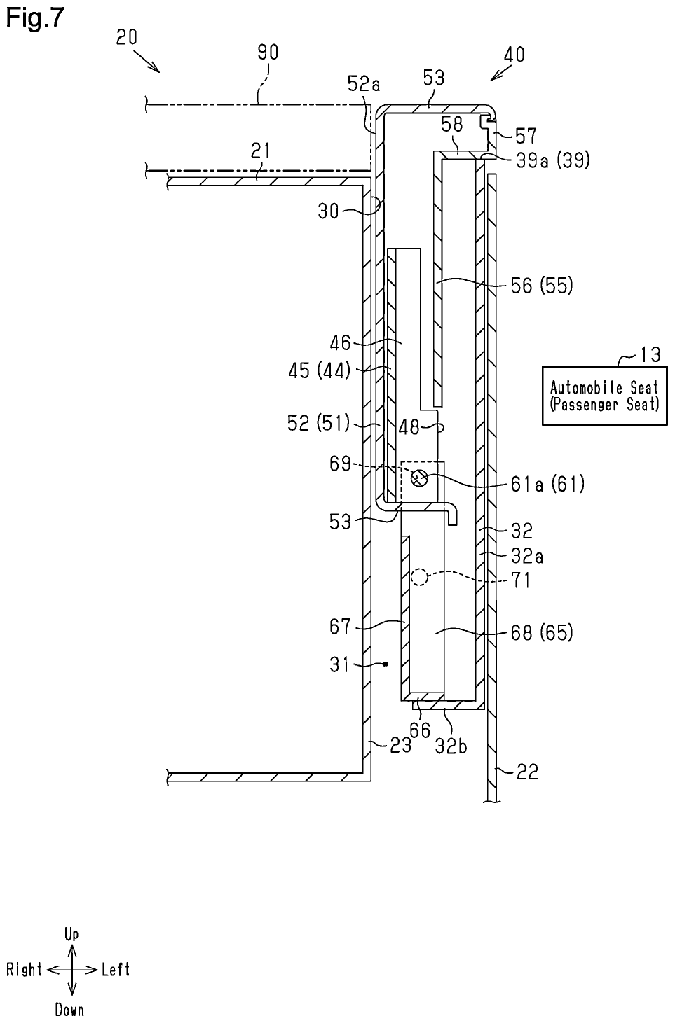

As shown in FIGS. 1 and 7, an accommodation portion 31 having an opening 30 at an upper end is arranged between the outer wall 22 and the inner wall 23, adjacent to each other, at a location adjacent to the recess 26 at one side in the right-left direction that is the left side in the present embodiment.

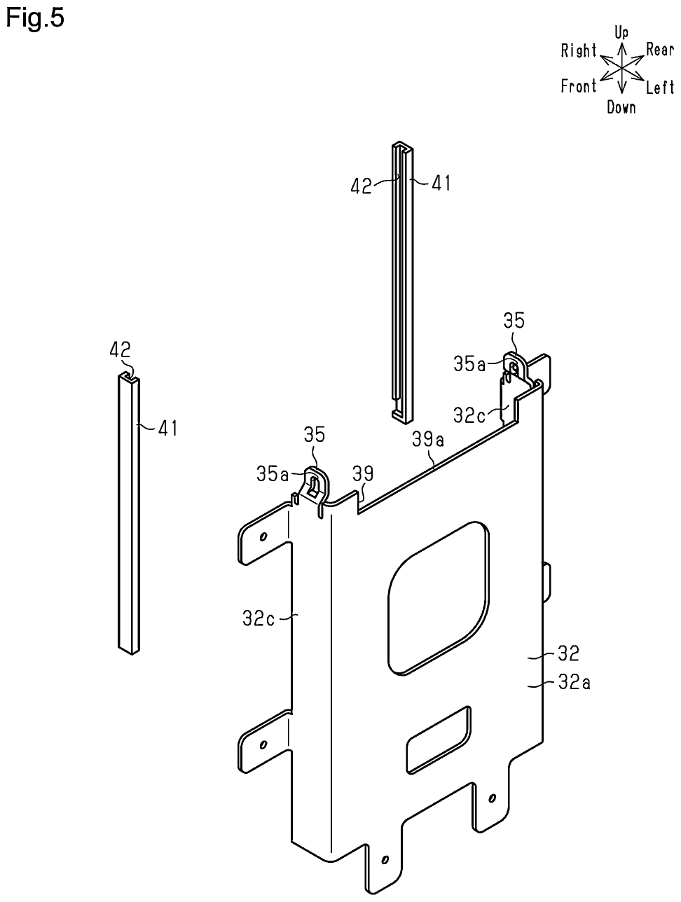

A metal bracket cover 32 is arranged in the accommodation portion 31. As shown in FIGS. 5 and 7, the bracket cover 32 includes a main plate portion 32a, a bottom plate portion 32b, and two opposing plate portions 32c .

The main plate portion 32a is substantially quadrangular and flat and is arranged at a location adjacent to the right side of the outer wall 22. The bottom plate portion 32b projects inward (rightward) from the lower edge of the main plate portion 32a. The opposing plate portions 32c each project inward (rightward) from the front edge and the rear edge of the main plate portion 32a. The opposing plate portions 32c are disposed parallel with each other and opposed to each other in the front-rear direction.

### 2.1. Vertical Rail 41

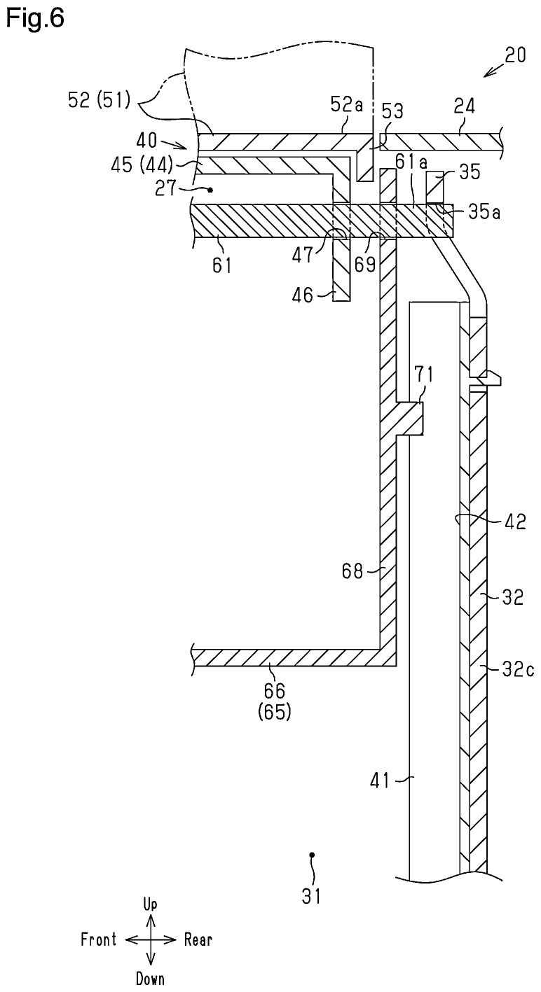

As shown in FIGS. 5 and 6, two vertical rails 41 are arranged at a location adjacent to the rear of the front-side opposing plate portion 32c and a location adjacent to the front of the rear-side opposing plate portion 32c. Each vertical rail 41 includes a vertical guide groove 42 extending in the vertical direction. The front-side vertical guide groove 42 is open at the rear end surface and the upper end surface of the vertical rail 41. The rear-side vertical guide groove 42 is open at the front end surface and the upper end surface of the vertical rail 41.

### 2.2. Side Table 40

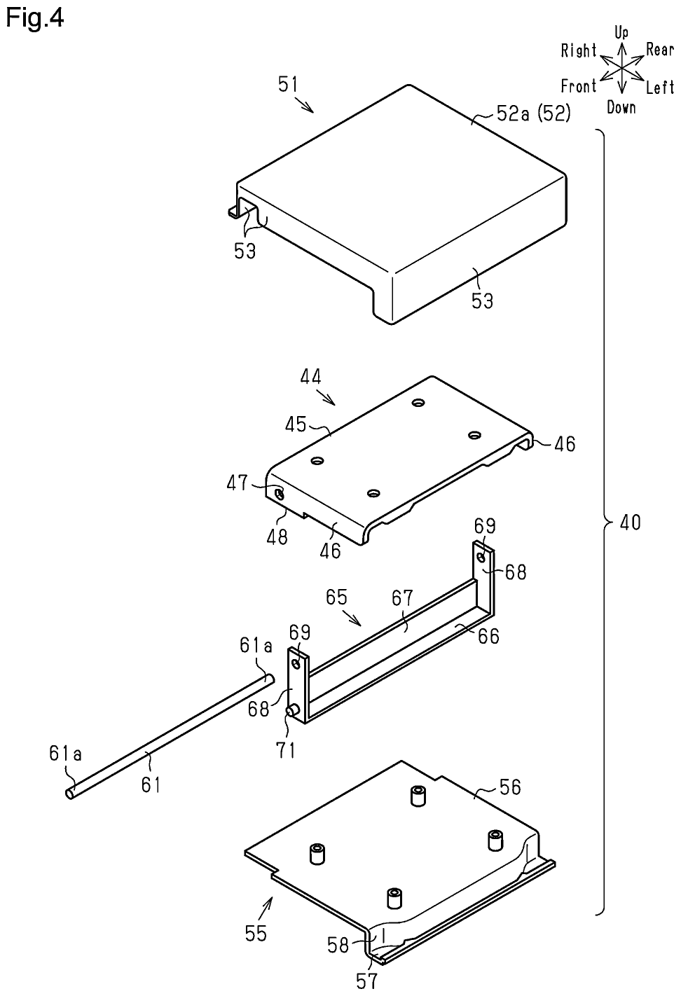

As shown in FIGS. 4 and 7, the side table 40 includes a table bracket 44 sandwiched between a table outer member 51 and a table inner member 55. The table outer member 51 and the table inner member 55 are made of, for example, a plastic material.

As shown in FIG. 4, the table outer member 51 includes a work plate portion 52 that is quadrangular and flat and four side plate portions 53 arranged on each side of the work plate portion 52. The surface of the work plate portion 52 that is farther from the table inner member 55 forms the surface of the side table 40. This surface is flat and serves as a work surface 52a for light work.

The table inner member 55 includes a main plate portion 56, an auxiliary plate portion 57, and a connecting plate portion 58. The main plate portion 56 and the auxiliary plate portion 57 are arranged parallel to the work plate portion 52 at a location spaced apart from the work plate portion 52. The distance between the work plate portion 52 and the main plate portion 56 is set to be less than the distance between the work plate portion 52 and the auxiliary plate portion 57. The connecting plate portion 58 extends in a direction orthogonal to the work plate portion 52 and connects the main plate portion 56 and the auxiliary plate portion 57.

The table bracket 44 is formed by, for example, bending a metal sheet. The table bracket 44 has a higher strength than the table outer member 51 and the table inner member 55. The table bracket 44 includes a main plate portion 45 that is quadrangular and flat and two opposing plate portions 46 disposed to be parallel and opposed to and spaced apart from each other in the front-rear direction. Each opposing plate portion 46 is orthogonally connected to the front edge or the rear edge of the main plate portion 45 and is elongated along the front edge and the rear edge. A shaft insertion hole 47 extends through each opposing plate portion 46 in the front-rear direction at one end in a direction along the front edge and the rear edge. A flat contact surface 48 is arranged at the one end of each opposing plate portion 46 at an edge opposite to the main plate portion 45.

### 2.3. Shaft Portion 61a

A shaft 61 is inserted through the shaft insertion holes 47 of the table bracket 44 to extend in the front-rear direction. The shaft 61 is made of, for example, metal. The shaft 61 has a front end and a rear end that each form a shaft portion 61a. The front-side shaft portion 61a projects frontward from the front-side opposing plate portion 46. As shown in FIG. 6, the rear-side shaft portion 61a projects rearward from the rear-side opposing plate portion 46.

2.4. Retainer 65 As shown in FIG. 6, the retainer 65 is axially supported at the front end and the rear end of the shaft 61 by the shaft portions 61a that project frontward and rearward from the front-side opposing plate portion 46 and the rear-side opposing plate portion 46.

The retainer 65 assists the vertical movement of the side table 40 between an accommodation position and an intermediate position, which will be described later, and also assists the rotation of the side table 40 between the intermediate position and a usage position. As shown in FIGS. 4, 6, and 8, the retainer 65 is arranged in the accommodation portion 31 to be movable in the vertical direction.

As shown in FIG. 4, the retainer 65 includes a bottom plate portion 66, a side plate portion 67, and two front and rear opposing plate portions 68. As shown in FIG. 7, the bottom plate portion 66 extends in a horizontal state in the front-rear direction above the bottom plate portion 32b of the bracket cover 32. The side plate portion 67 extends in an upright state in the front-rear direction. The lower edge of the side plate portion 67 is continuous with the bottom plate portion 66.

The opposing plate portions 68 are disposed to be parallel and opposed to and spaced apart from each other in the front-rear direction. Each opposing plate portion 68 is flat and longer in the vertical direction than in the right-left direction. The front-side opposing plate portion 68 is fixed to the front ends of the bottom plate portion 66 and the side plate portion 67. The rear-side opposing plate portion 68 is fixed to the rear ends of the bottom plate portion 66 and the side plate portion 67.

As shown in FIG. 4, a shaft insertion hole 69 extends through the upper portion of each opposing plate portion 68 in the front-rear direction. The front-side shaft portion 61a is inserted through the front-side shaft insertion hole 69. The rear-side shaft portion 61a is inserted through the rear-side shaft insertion hole 69. With this structure, the upper end of the retainer 65 is rotatable about the shaft portions 61a relative to the table bracket 44.

The front-side shaft portion 61a projects frontward from the front-side opposing plate portion 68 of the retainer 65. As shown in FIG. 6, the rear-side shaft portion 61a projects rearward from the rear-side opposing plate portion 68 of the retainer 65. The front and rear shaft portions 61a are inserted into the vertical guide grooves 42 of the corresponding vertical rails 41 to be slidable in the vertical direction.

As shown in FIG. 4, a pin 71 projects frontward from the front-side opposing plate portion 68 of the retainer 65, and as shown in FIG. 7, a pin 71 projects rearward from the rear-side opposing plate portion 68. The two pins 71 are arranged below the shaft insertion holes 69.

The pin 71 of the front-side opposing plate portion 68 is inserted into the vertical guide groove 42 of the front-side vertical rail 41 to be slidable in the vertical direction. The pin 71 of the rear-side opposing plate portion 68 is inserted into the vertical guide groove 42 of the rear-side vertical rail 41 to be slidable in the vertical direction.

### 2.5. Shaft Support Portion 35

As shown in FIG. 6, the upper end of each opposing plate portion 32c of the bracket cover 32 includes a shaft support portion 35 through which a support hole 35a extends. Each support hole 35a is arranged above the corresponding vertical guide groove 42. In other words, when the shaft portions 61a are raised from the vertical guide grooves 42 or when the shaft portions 61a are lowered from the support holes 35a to the vertical guide grooves 42, the movement of the shaft portions 61a is not blocked between vertical guide grooves 42 and the support holes 35a .

Each support hole 35a is elongated substantially in the vertical direction. The support hole 35a is slightly wider than the diameter of the shaft portion 61a.

### 2.6. Rotation Restricting Portion 39a

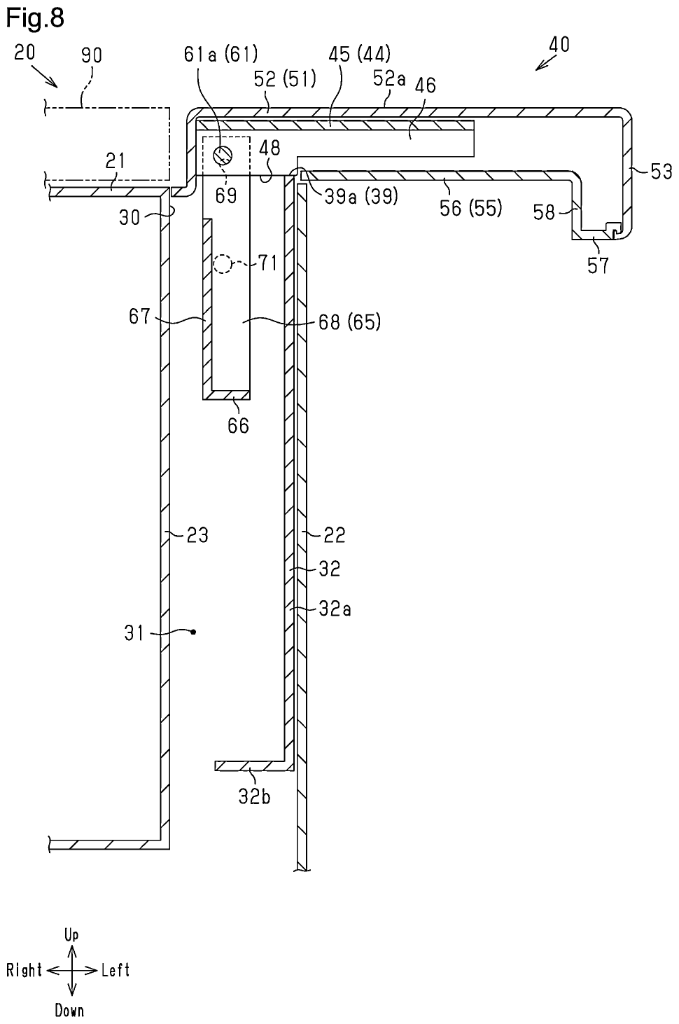

As shown in FIG. 8, a cutout portion 39 is arranged at the upper end of the main plate portion 32a of the bracket cover 32. The bottom of the cutout portion 39 forms a rotation restricting portion 39a that restricts rotation of the side table 40 by contacting the contact surfaces 48 of the table bracket 44.

### 2.7. Positions of Side Table 40

The side table 40 configured as described above is movable to an accommodation position, an intermediate position, and a usage position.

At the accommodation position, as shown in FIGS. 1 and 7, the side table 40 is accommodated in the accommodation portion 31 in an upright state. At the intermediate position, as shown by the long-dash double-short-dash lines in FIGS. 2 and 6, the side table 40 is exposed upward from the accommodation portion 31 in the upright state. At the intermediate position, the shaft portion 61a is rotatably supported by the shaft support portion 35 (refer to FIG. 6).

At the usage position, the side table 40 is rotated about the shaft 61 and the contact surfaces 48 are engaged with the rotation restricting portion 39a, so that the side table 40 projects leftward from the upper end of the console body 21 in a horizontal state while closing the opening 30 of the accommodation portion 31 (refer to FIGS. 2 and 8).

In this manner, the side table 40 is vertically movable between the accommodation position and the intermediate position, and is also rotatable between the intermediate position and the usage position.

### 3. Armrest 80 and Center Table 90

As shown in FIGS. 1 to 3, the position of the armrest 80 can be changed. The armrest 80 is arranged on a base member (not shown).

The armrest 80 includes an upper wall 80a, a left wall 80b, and a right wall 80c that have a trapezoidal cross section when viewed from the front in FIG. 1. The armrest 80 also includes a rear end wall 80d and an opening 80e at the front end. The left wall 80b and the right wall 80c are arranged close to the rear portions of the upper surfaces of the upper walls 24 to be continuous with the rear portions of the upper surfaces.

The armrest 80 includes guide grooves (not shown) each extending in the front-rear direction in the inner surfaces of the left wall 80b and the right wall 80c that are opposed to each other. The base member (not shown) includes projections that are slidably engaged with the guide grooves (not shown). The projections, slidably engaged with the guide grooves, allow the armrest 80 to be moved between a reference position shown in FIG. 1 and an extended position shown in FIG. 3.

The reference position shown in FIG. 1 is for covering the entire opening of the recess 25. The extended position is for allowing opening of part of the opening of the recess 25.

The rear end of the base member (not shown) is axially supported at the rear portion of the console body 21 between the inner walls 23, so that when the front end of the armrest 80 is lifted upward, the armrest 80 is in a raised state together with the center table 90. The armrest 80 can be in the raised state when positioned either at the reference position or the extended position.

The center table 90 is arranged in an accommodation space defined by the upper wall 80a, the left wall 80b, the right wall 80c, the rear end wall 80d, and the base member of the armrest 80. The armrest 80 in a non-raised state as shown in FIGS. 1 and 3 covers the opening of the recess 25 as shown in FIG. 1.

### Operation of First Embodiment

Operation of the above-described present embodiment will now be described.

1. Movement of Side Table 40 from Accommodation Position to Usage Position

When the side table 40 is used, the occupant temporarily moves the side table 40 from the accommodation position to the intermediate position and subsequently moves the side table 40 to the usage position.

Specifically, the occupant raises the side table 40 by, for example, pinching and pulling up (lifting up) a portion (upper end) of the side table 40 at the accommodation position shown in FIG. 7 that is exposed from the accommodation portion 31. This exposes the side table 40 upward from the accommodation portion 31.

As shown in FIGS. 6 and 7, as the side table 40 is raised, the retainer 65 is also raised together with the side table 40. In this case, the shaft portion 61a and the pin 71 slide upward along the vertical guide groove 42 of the corresponding vertical rail 41. The direction in which the shaft portion 61a and the pin 71 are moved is restricted to the vertical direction by the vertical rail 41. Thus, looseness between the side table 40 and the retainer 65 is avoided while the side table 40 is smoothly raised.

When the side table 40 is further pulled up, each shaft portion 61a is moved from the corresponding vertical guide groove 42 to the support hole 35a, and slides upward in the support hole 35a .

As shown by the long-dash double-short-dash lines in FIGS. 2 and 6, when the side table 40 is pulled up to the intermediate position, the shaft portions 61a contact the inner wall surfaces of the support holes 35a at the upper ends and further upward movement is restricted. The shaft portions 61a are rotatably supported by the shaft support portions 35.

At the intermediate position, a substantial part of the side table 40 is exposed upward from the accommodation portion 31 in the upright state. The contact surfaces 48 of the table bracket 44 still remain spaced apart from the rotation restricting portion 39a. Further, as shown in FIG. 6, the retainer 65 is positioned in the upright state at the upper portion of the accommodation portion 31. Each pin 71 is positioned in the corresponding vertical guide groove 42. As shown in FIG. 8, the bottom plate portion 66 of the retainer 65 is positioned upward from the bottom plate portion 32b of the bracket cover 32. Further, the occupant rotates the side table 40 about the shaft portions 61a relative to the console body 21 toward the lower left at a side extending away from the automobile seat 13 in the width direction. In this case, since the shaft portions 61a are supported by the shaft support portions 35, the position of the shaft portions 61a is stabilized. As shown in FIGS. 2, 6, and 8, when the side table 40 is rotated to the usage position, the contact surfaces 48 of the table bracket 44 contact the rotation restricting portion 39a of the bracket cover 32.

This contact allows the work surface 52a of the side table 40 to be horizontal and face upward as shown by the solid lines in FIG. 2. In this state, the occupant can place an item on the work surface 52a of the horizontal side table 40.

As described above, the side table 40 positioned at the usage position is arranged adjacent to the recess 26, serving as the first recess, in the left direction (first direction). The recess 27, serving as the second recess, is adjacent to the recess 26 in the forward direction (second direction).

In this state, when the occupant pushes an item placed on the work surface 52a of the side table 40 toward the console body, the pushed item can be caught in the recess 26 or the recess 27 adjacent to the side table 40.

As a result, the movement of the pushed item out of the console is avoided. Thus, the occupant only needs to pick up the item in the recess 26 or the recess 27, and the effort to pick up the pushed item is eased.

### 2. Movement of Side Table 40 From Usage Position to Accommodation Position

A case in which the side table 40 is returned from the usage position to the accommodation position will now be described.

The occupant returns the side table 40 from the horizontal state to the upright state above the accommodation portion 31. The occupant lowers the side table 40 in the upright state.

As the side table 40 is lowered, each shaft portion 61a moves from the corresponding support hole 35a to the vertical guide groove 42 positioned below. The retainer 65 connected to the side table 40 by the two shaft portions 61a moves downward in the accommodation portion 31 together with the side table 40.

The shaft portions 61a and the pins 71 slide downward along the vertical guide

grooves 42. When the side table 40 is lowered to the accommodation position, as shown in FIG. 7, the bottom plate portion 66 of the retainer 65 contacts the bottom plate portion 32b of the bracket cover 32, and the connecting plate portion 58 of the table inner member 55 is engaged with the rotation restricting portion 39a of the bracket cover 32. This restricts downward movement of the side table 40 and maintains the side table 40 at the accommodation position.

The present embodiment has the following features.

(1) When the side table 40 of the present embodiment is positioned at the usage position, the side table 40 extends in a direction extending away from the console body 21. In other words, the side table 40 is configured to be used in a position in which the side table 40 extends away from the console body 21. Further, a direction in which the side table 40 extends away from the console body 21 is referred to as a left direction (first direction), and the forward direction intersecting the left direction (first direction) is referred to as a second direction. The upper surface of the console body 21 includes the recess 26 (first recess), adjacent to the side table 40, and the recess 27 (second recess), adjacent to the recess 26 (first recess) in the forward direction (second direction).

With the above-described structure, when the occupant pushes an item on the side table 40 toward the console body 21, the pushed item can be caught in the recess 26, adjacent to the side table 40, or the recess 27. As a result, the movement of the pushed item out of the console is avoided. Thus, the occupant only needs to pick up the item in the recesses 26 or the recess 27, and the effort to pick up the pushed item is eased.

### Second Embodiment

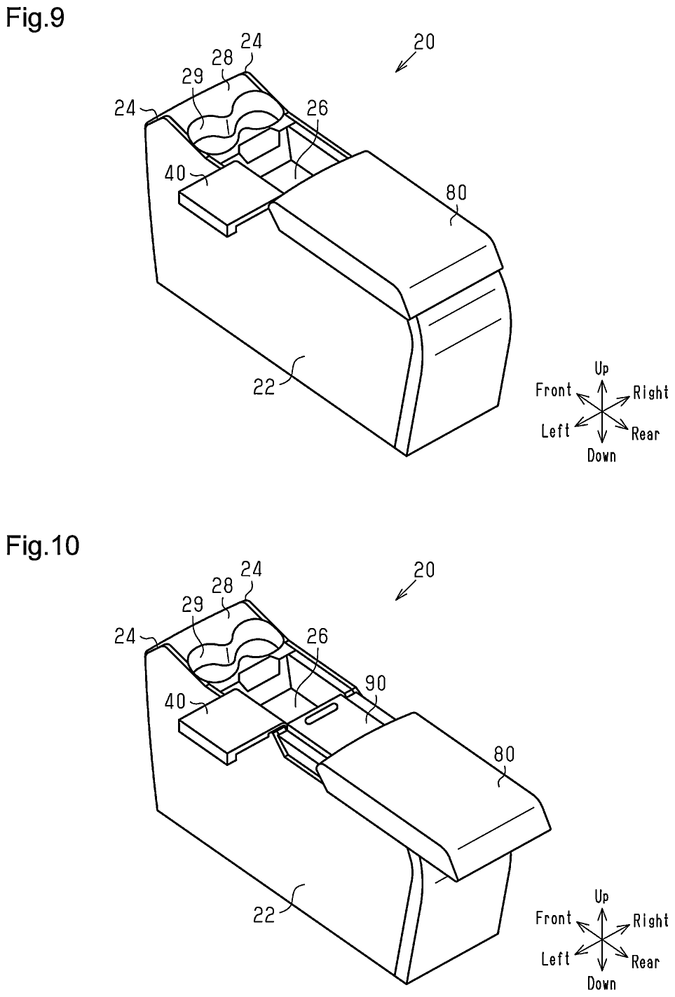

Next, an automobile console according to a second embodiment will now be described with reference to FIGS. 9 to 12. Like or the same reference numerals are given to those components that are like or the same as the corresponding components of the console 20 of the first embodiment. Such components will not be described in detail. The description hereafter will focus on differences from the first embodiment.

The console 20 of the present embodiment is different from that of the first embodiment in that the recess 27 of the first embodiment is omitted and the recess 26 and the upper surface 28 including the cup holder 29 are arranged adjacent to each other. Other structures of the console 20 of the present embodiment are the same as those of the first embodiment.

Specifically, the cup holder 29 of the present embodiment is arranged to be adjacent to the recess 26 in the forward direction. Thus, when the recess 26 is referred to as a first recess, the cup holder 29 corresponds to a second recess adjacent to the recess 26 in the forward direction. Further, the upper surface 28 in which the cup holder 29 is arranged is an inclined surface having a height that decreases toward the recess 26 (first recess). In other words, the upper surface of the console body 21 includes an inclined surface (upper surface 28) in which the cup holder 29 is arranged and has a height that decreases toward the first recess (recess 26).

### Operation of Second Embodiment

The operation of the console 20 of the present embodiment will now be described.

### 1. When Console 20 is in State Shown in FIG. 9

With the console 20 of the present embodiment, when the side table 40 is positioned at the horizontal usage position, as shown in FIG. 9, the armrest 80 of the console 20 can be positioned at the reference position and in the non-raised state.

In such a state of the console 20, when the occupant pushes an item on the side table 40 toward the console body 21, the pushed item can be caught in the recess 26 adjacent to the side table 40.

Further, the pushed item may enter the cup holder 29.

Alternatively, when the occupant pushes the item on the side table 40 onto the upper surface 28 of the console body 21, the item hitting the upper surface 28, which is the inclined surface, may be guided into the recess 26. In this case, the guided item is caught in the recess 26. As a result, the movement of the pushed item out of the console is avoided. Thus, the occupant only needs to pick up the item in the recess 26 or the cup holder 29, and the effort to pick up the pushed item is eased.

### 2. When Console 20 is in State Shown in FIG. 10

When the side table 40 of the console 20 is positioned at the horizontal usage position, as shown in FIG. 10, the occupant can position the armrest 80 of the console 20 at the extended position and in the non-raised state.

Even in such a case, when the occupant pushes an item on the side table 40 in the same manner as described with reference to FIG. 9, the movement of the item out of the console is avoided. Thus, the occupant only needs to pick up the item in the recess 26 or the cup holder 29, and the effort to pick up the pushed item is eased.

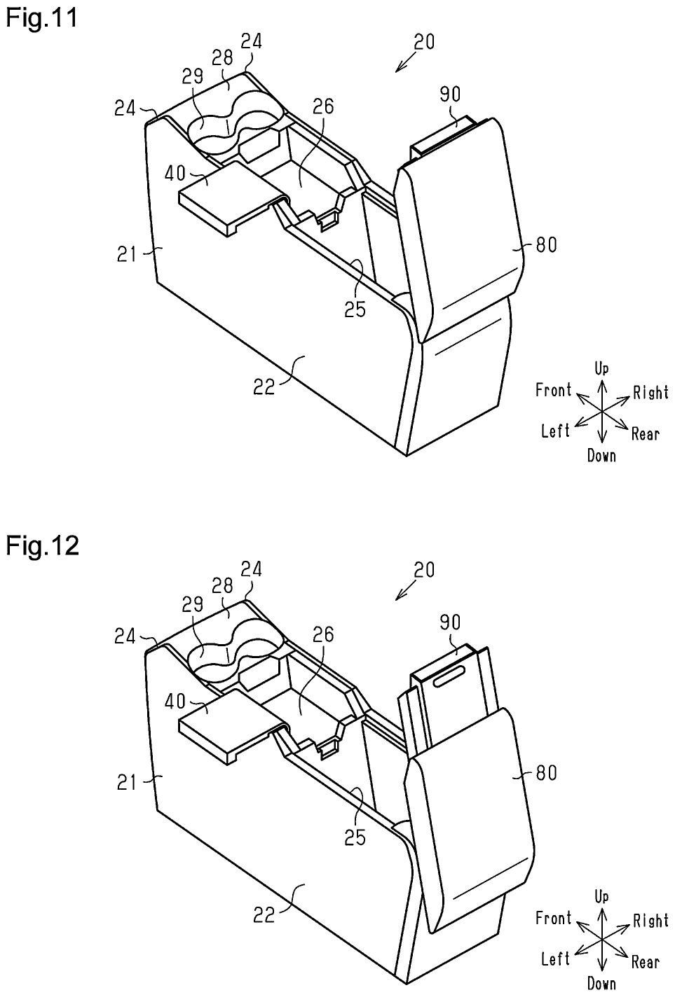

### 3. When Console 20 is in State Shown in FIG. 11

With the console 20 of the present embodiment, when the side table 40 is positioned at the horizontal usage position, as shown in FIG. 11, the armrest 80 of the console 20 can be positioned at the reference position and in the raised state. In this case, the recess 25 is open.

In such a state of the console 20, when the occupant pushes an item on the side table 40 toward the console body 21, the pushed item may enter the recess 25 in addition to the likely other areas described with reference to FIG. 9. When the recess 26 is referred to as a first recess, the recess 25 corresponds to a second recess adjacent to the recess 26 in the reverse direction. In this case, the reverse direction corresponds to a second direction intersecting the first direction.

In such a case, the recesses 25, the recess 26, or the cup holder 29 avoid the movement of the pushed item out of the console. Thus, the occupant only needs to pick up the item in the recess 25, recess 26, or the cup holder 29, and the effort to pick up the pushed item is eased.

### 4. When Console 20 is in State Shown in FIG. 12

When the side table 40 of the console 20 is positioned at the horizontal usage position, as shown in FIG. 12, the armrest 80 of the console 20 can be positioned at the extended position and in the raised state.

Even in such a case, the movement of a pushed item out of the console is avoided in the same manner as described with reference to FIG. 11. Thus, the occupant only needs to pick up the item in the recess 25, recess 26, or the cup holder 29, and the effort to pick up the pushed item is eased.

The present embodiment has the following features.

(1) In the console 20 of the present embodiment, the upper surface of the console body 21 includes an inclined surface having a height that decreases toward the recess 26 (first recess). The cup holder 29 (second recess) is formed in the inclined surface.

With the above-described structure, when an item pushed by the occupant hits the inclined surface including the cup holder 29 (second recess), the item can enter the recess 26 (first recess). As a result, the movement of the pushed item out of the console is avoided. Thus, the occupant only needs to pick up the item in the recess 26 (the first recess), and the effort to pick up the pushed item is eased.

(2) The console 20 of the present embodiment includes the cup holder 29 serving as the second recess. With the above-described structure, a pushed item can be caught in the cup holder 29 serving as the second recess. Thus, the occupant only needs to pick up the item in the cup holder 29, and the effort to pick up the pushed item is eased.

The above-described embodiments may be modified as follows. The above-described embodiments and the following modifications can be combined as long as the combined modifications remain technically consistent with each other.

In the embodiment described above, the side table 40 extends leftward from the left-side outer wall 22. However, a side table extending rightward from the right-side outer wall 22 of the console body 21 may be further arranged. In this case, the right direction with respect to the newly arranged side table corresponds to the first direction.

In the embodiment described above, the side table 40 extending leftward from the left-side outer wall 22 may be omitted, and a side table extending rightward from the right-side outer wall 22 of the console body 21 may be arranged. In this case, the right direction with respect to the side table arranged in this manner corresponds to the first direction.

In the embodiment described above, the side table 40 can be accommodated in the console body 21. Instead, the side table 40 may be attached to the outer surface of the outer wall 22 to be in the upright state and the horizontal state.

In the embodiment described above, the side table 40 is moved between the accommodation position, the intermediate position, and the usage position. Instead, the side table 40 may be directly fixed to the side wall of the console 20 to be horizontal. Alternatively, the side table 40 may be fixed to the floor in proximity to the side wall of the console 20.

The center table 90 may be omitted.

The console of the present disclosure may be applied to a console installed in a vehicle other than an automobile.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A console, comprising:
a console body; and
a table configured to be used in a position in which the table extends away from the console body, wherein
a direction in which the table extends away from the console body is referred to as a first direction, and a direction intersecting the first direction is referred to as a second direction,
an upper surface of the console body includes a first recess and a second recess,
the first recess is adjacent to the table, and
the second recess is adjacent to the first recess in the second direction.

2. The console according to claim 1, wherein
the upper surface includes an inclined surface having a height that decreases toward the first recess, and
the second recess is formed in the inclined surface.

3. The console of claim 1, wherein the second recess includes a cup holder.
